(19) United States
(12) Patent Application Publication
(10) Pub. No.: US 2001/0051874 A1
(43) Pub. Date: Dec. 13, 2001

(54) Image processing device and printer having the same

(76) Inventor: Junichi Tsuji, Kanagawa (JP)

Correspondence Address: SUGHRUE, MION, ZINN, MACPEAK & SEAS, 2100 Pennsylvania Avenue, N.W., Washington, DC, 20037, US

(21) Appl. No.: 09/802,895

(22) Filed: Mar. 12, 2001

(30) Foreign Application Priority Data
Mar. 13, 2000 (JP) 2000-069073
Jan. 25, 2001 (JP) 2001-016505

(51) Int. Cl. G10L 21/00; G10L 11/00

(52) U.S. Cl. 704/270

(57) ABSTRACT

A digital printer prints an image to photographic paper according to image data. A speech data input unit inputs speech data associated with the image data for representing speech. The speech data is subjected to tone conversion. An image forming unit prints the tone-converted speech data to the photographic paper in association with the image.

### BACKGROUND OF THE INVENTION

1. Field of the Invention

The present invention relates to an image processing device and a printer having the same. More particularly, the present invention relates to an image processing device capable of outputting speech data together with image data, and a printer having the same.

2. Description Related to the Prior Art

There are various types of printers according to digital techniques. In a printer, a frame recorded in an exposed photo film is printed. Also, image data is obtained by use of a digital camera, and is input to the printer for printing. Furthermore, a user may send the image data to a photo finishing agent by use of the Internet, so as to produce a print in a digital printing system. This is advantageous because the user does not need to come to the photo finishing agent directly.

Among various types of printing service, there is suggestion of processing of acoustic information associated with the image data. For example, U.S. Pat. No. 5,546,145 (corresponding to JP-A 8-076288) and U.S. Pat. No. 5,692,225 (corresponding to JP-A 8-082856) disclose writing of speech data. In a digital printing system, the speech data associated with the image data is retrieved from a memory card or other recording medium, is converted into a bar code, so the bar code is printed together with an image. In playing back the speech data, the bar code is read from the print together with a bar code reading pen or a reader of a suitable type.

However, there is a shortcoming in the above playback of the speech data, because the speech is original itself as recorded by the user, is difficult to understand aurally. Some nervous user is likely to hesitate to record his or her original voice, and may be reluctant for any unknown person to hear the original voice. Furthermore, a user may hesitate to send his or her original voice by the Internet to a photo finishing agent together with the image data.

### SUMMARY OF THE INVENTION

In view of the foregoing problems, an object of the present invention is to provide an image processing device capable of outputting speech data together with image data in a reliably recognizable manner, and a printer having the same.

In order to achieve the above and other objects and advantages of this invention, an image processing device for processing image data includes a speech data input unit for inputting speech data associated with the image data for representing speech. A voice tone convertor subjects the speech data to tone conversion. A speech data output unit outputs the tone-converted speech data in association with the image data.

In a preferred embodiment, the voice tone convertor stores plural sets of tone mode information. Furthermore, a voice tone selector selects one of the plural sets of the tone mode information, wherein the voice tone convertor subjects the speech data to tone conversion according to the selected tone mode information.

In another preferred embodiment, the voice tone convertor generates conversion data for tone conversion control, and sends the conversion data to the speech data output unit. The tone-converted speech data is constituted by the speech data before being converted and the conversion data.

Furthermore, a text data output unit outputs text data in association with the image data, the text data representing text.

Furthermore, a speech/text convertor converts the speech data from the speech data input unit into the text data.

Furthermore, a text data input unit is externally operable, for inputting the text data.

The text data includes at least one of a letter, a number and a sign.

Furthermore, a text data input unit inputs text data associated with the image data for representing text. A text/speech convertor converts the text data into speech data, and sends the speech data to the speech data output unit.

In a preferred embodiment, an image processing device for processing image data includes a data input unit for inputting first data associated with the image data. A convertor converts the first data into second data. A data output unit outputs the second data in association with the image data.

The first data is text data for representing text, and the second data is speech data for representing speech.

The data output unit further outputs the text data in association with the image data.

Furthermore, the first data is speech data for representing speech, the second data is text data for representing text.

In another preferred embodiment, an image processing device for processing image data includes a text data input unit for inputting text data associated with the image data for representing text. A data output unit outputs the text data and conversion data in association with the image data, the conversion data being adapted to production of speech according to the text data.

In a preferred embodiment, a printer for printing an image to recording material according to image data includes a speech data input unit for inputting speech data associated with the image data for representing speech. A voice tone convertor subjects the speech data to tone conversion. A speech data recorder records the tone-converted speech data to the recording material in association with the image.

### BRIEF DESCRIPTION OF THE DRAWINGS

The above objects and advantages of the present invention will become more apparent from the following detailed description when read in connection with the accompanying drawings, in which:

FIG. 1 is a block diagram illustrating a digital printing system including an image processing device;

FIG. 2 is an explanatory view in plan, illustrating a photographic print;

FIG. 3 is a flow chart illustrating a process of modifying and recording speech data;

FIG. 4 is a block diagram illustrating another preferred digital printing system capable of writing speech data bar code;

FIG. 5A is an explanatory view illustrating tone-converted speech data;

FIG. 5B is an explanatory view illustrating a combination of conversion data and original speech data;

FIG. 6 is a block diagram illustrating still another preferred digital printing system capable of writing text data.

### DETAILED DESCRIPTION OF THE PREFERRED

### Embodiment(s) of the Present Invention

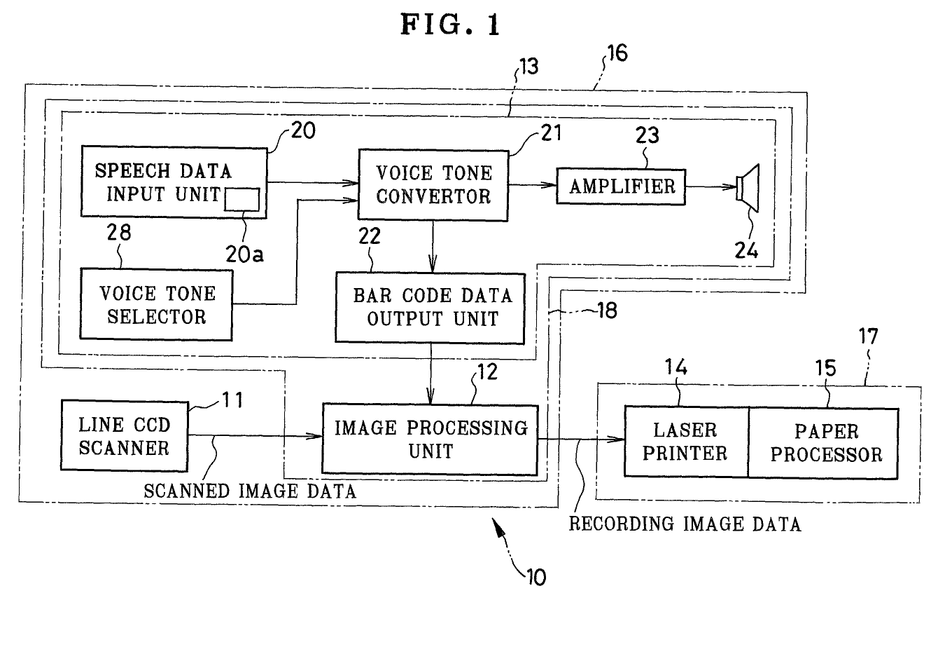

In FIG. 1, a digital printing system 10 of the invention is illustrated. The digital printing system 10 is constituted by a line CCD scanner 11, an image processing unit 12, a speech data convertor component 13, a laser printer or video printer 14 as image forming unit, and a paper processor 15. An input machine 16 is a single machine including the line CCD scanner 11, the image processing unit 12 and the speech data convertor component 13. An output machine 17 is a single machine including the laser printer 14 and the paper processor 15. An image processing device 18 of the present invention consists of a combination of the image processing unit 12 and the speech data convertor component 13.

The line CCD scanner 11 is a device well-known to those skilled in the art, has a photo film holder or carrier for feeding the exposed photo film, and reads each of images from the photo film. The line CCD scanner 11 obtains scanned image data, and sends the same to the image processing unit 12.

The speech data convertor component 13 has a speech data input unit 20, a voice tone convertor 21, and a bar code data output unit 22 as speech data output unit. The speech data input unit 20 is adapted to inputting speech data stored in a recording medium such as a memory card and a magnetic recording layer of the photo film at the time of or after an exposure in a camera. A memory 20a stores the speech data in a temporary manner.

The speech data is read from the memory 20a, and sent to the voice tone convertor 21. The voice tone convertor 21 is constituted by a known circuit for converting the tone of voice constituting the speech. A voice tone selector 28 is connected to the voice tone convertor 21, and externally operated to designate one of modes of tone conversion. To convert the voice tone, the speech is separated into a pitch component and a spectral envelope component, which are subjected to processing known in the art. In the present embodiment, the voice tone convertor 21 is settable in first and second tone modes, and when in the first mode, converts the speech into a tone of a standard voice of a female adult, and when in the second mode, converts the speech into a tone of a standard voice of a male adult. Furthermore, voices of particular professional announcers, narrators, actors or the like may be preset for determining modes of converting the tone. Various known techniques of tone conversion can be used. For example, JP-A 9-244693 discloses tone conversion according to a model of speech data of a particular person. Furthermore, a personal computer may be used for tone conversion in combination of tone converting software stored therein. An amplifier 23 and a loud speaker 24 are connected with the voice tone convertor 21, and when desired, are used to play back the speech before or after conversion of the tone. It is to be noted that, in the present embodiment, the first and second tone modes are determined for two tones of speech. However, two or more tone modes may be determined for selection of one of tone converting techniques different from one another.

The bar code data output unit 22 converts the tone-converted speech data into a bar code data, which is sent to the image processing unit 12.

The image processing unit 12 determines one of image frames to be printed according to the scanned image data, and subjects the scanned image data to image processing known in the art. At the time of image processing, the image processing unit 12 produces a bar code image according to bar code data from the bar code data output unit 22, and effects such image synthesis as to insert the bar code image into a portion under the image frame to be printed. Furthermore, the synthesized image is converted into recording data for the digital printing, and sends the same to the laser printer 14.

The laser printer 14 includes laser light sources of Red, Green and Blue colors and a modulator unit. According to recording image data, the laser light is modulated, and then applied to photographic paper. An image is recorded to the photographic paper in a form of a latent image by scanning and exposure. The paper processor 15 subjects the exposed photographic paper to various processes including color development, bleaching/fixation, water washing, and drying. Thus, an image is created in the photographic paper.

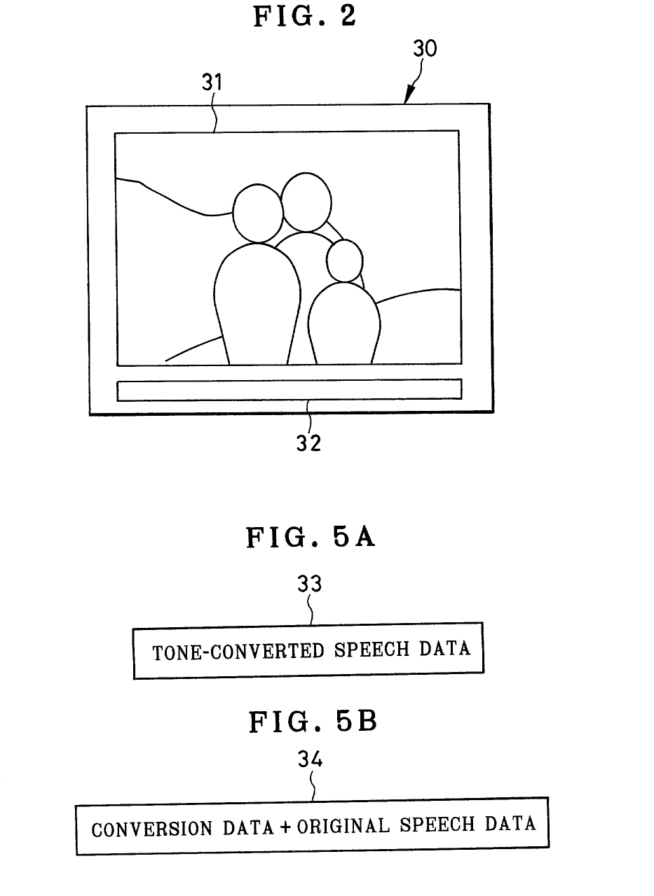

In FIG. 2, a print 30 is depicted, which is obtained by the laser printer 14 from photographic paper as photosensitive recording material. An image 31 is printed in the print 30, in which a speech data bar code 32 is also recorded. A bar code reader or bar code reading pen is used to read the speech data bar code 32, to play back the speech data. The speech data, after the tone conversion by the voice tone convertor 21, is data of speech of easily recognizable tone. Note that, instead of using a bar code reader specified to the tone conversion of the embodiment, it is possible to use a general-purpose scanner, and to read the bar code for the purpose of playing back the speech.

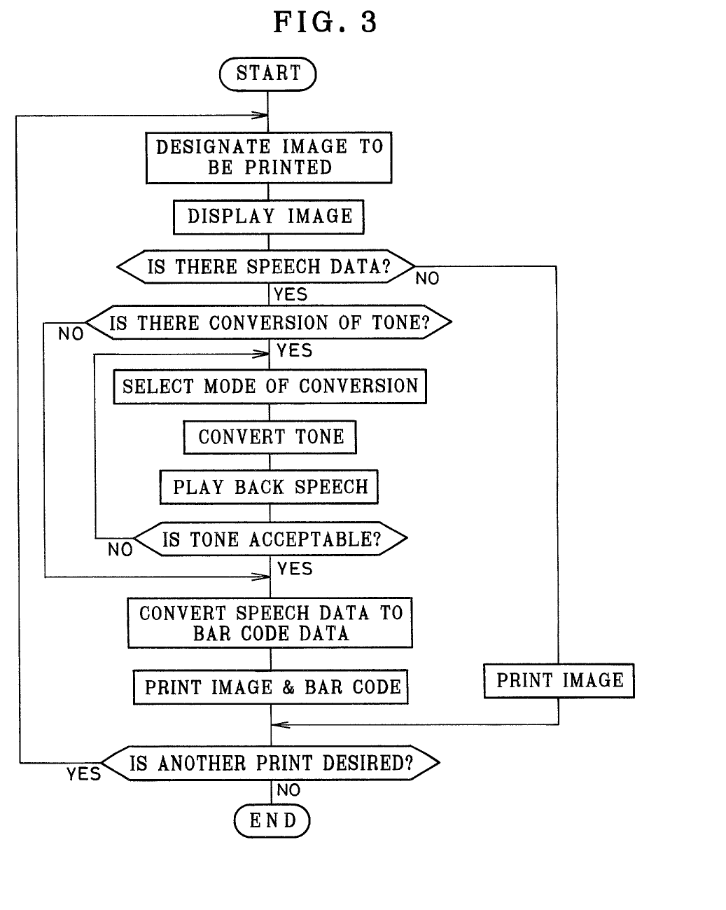

In FIG. 3, a flow of printing according to the embodiment is depicted. At first, the line CCD scanner 11 reads each of image frames in the photo film. The image frames being read are displayed in a display panel of the image processing unit 12 one after another. Also, a memory card or other recording medium is set in the speech data input unit 20, to read the speech data of a selected image frame. At the time of accepting an order, there are various kinds of information written on a surface of a photograph bag, including existence or lack of speech data, and existence or lack of tone conversion in addition to a printing size, a selected one of glossy finish or silk surface finish. According to the information, an operator operates the system to effect the tone conversion for the selected image frame with which speech data exists and conversion is desired. The tone-converted speech data is played back. If the tone-converted speech is regarded as acceptable by the operator, then the speech data bar code 32 after the conversion is recorded with the image 31. The print 30 in FIG. 2 is produced. Note that, in the present embodiment, the operator checks the tone-converted speech. However, it is possible to record the tone-converted speech data automatically without being checked by an operator.

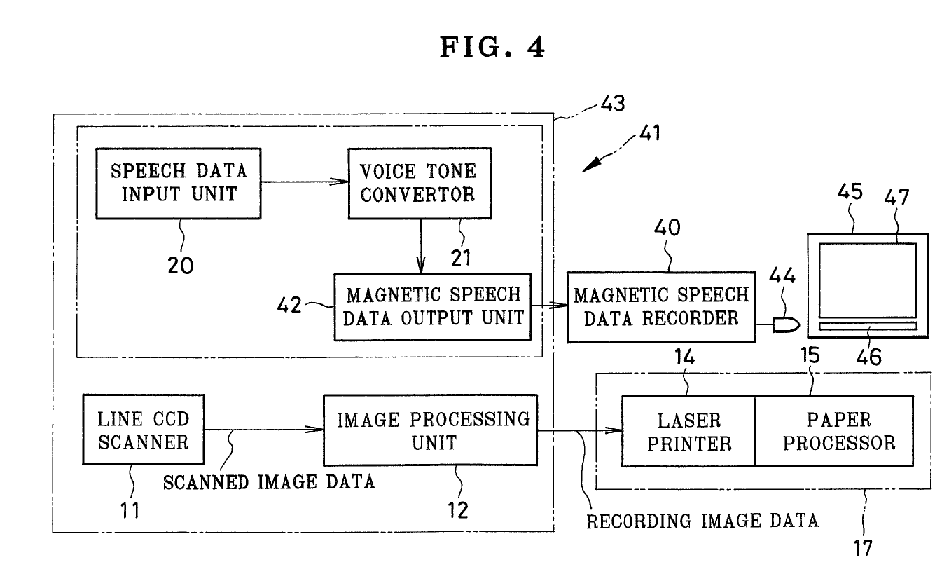

In the above embodiment, the speech data is recorded in the print in the bar code form. Also, forms in which the speech data is recorded may be other than the bar code form. Furthermore, FIG. 4 illustrates an embodiment in which speech data is magnetically recorded. A digital printing system 41 is provided with a magnetic speech data recorder 40. An input machine 43 includes a magnetic speech data output unit 42, which receives the tone-converted speech data from the voice tone convertor 21, and converts the same into magnetic speech data. A magnetic head 44 in the magnetic speech data recorder 40 writes the magnetic speech data 46 to a magnetic recording region of a print 45 obtained from photographic paper as photosensitive recording material. An image 47 is so disposed in the print 45 that the magnetic recording region is lower than the image 47. Alternatively, a magnetic recording layer may be overlaid on the entirety or part of a rear surface of the print 45. The magnetic speech data 46 can be recorded magnetically to the rear surface of the print 45. So the image 47 can be disposed in a frame region without any margin in a recording surface of the print 45. In FIG. 4, elements similar to those in FIG. 1 are designated with identical reference numerals.

Furthermore, it is possible to record the text data magnetically to the print 45 in a suitable form.

Also, it is possible to use a recording sheet in which an IC memory is incorporated. Speech data may be recorded to the IC memory. Connection to the IC memory may be a contact type in which a pin is used, and also may be a non-contact type in which electromagnetic induction is used. If the memory has a sufficiently large capacity, it is possible to write both the tone-converted speech data and the original speech data.

In FIGS. 5A and 5B, types of speech data to be recorded are depicted. In FIG. 5A, tone-converted speech data 33 is depicted, which is obtained by subjecting the original speech data to the conversion of the tone. In FIG. 5B, speech/conversion data set 34 is constituted by conversion data and original speech data. The tone-converted speech data 33 and the speech/conversion data set 34 are used to create the speech data bar code 32 depicted in FIG. 2. Furthermore, the tone-converted speech data 33 and the speech/conversion data set 34 are magnetically recorded as the magnetic speech data 46 in the magnetic recording region of FIG. 4. In FIG. 5B, the speech/conversion data set 34 includes the conversion data, which is a combination of designation data for a tone converting control type and various parameters. In a player device, tone-converted speech data is created according to the original speech data and the conversion data, and plays back the speech in the converted tone.

Note that, instead of combining a mode designating data with parameters to constitute the conversion data, it is possible that conversion data is constituted by designation data for designating one of voices of a male adult and a female adult. In this case, a player device outputs speech in the tone of male adult by converting the original speech data and the designation data for the voice of a male adult.

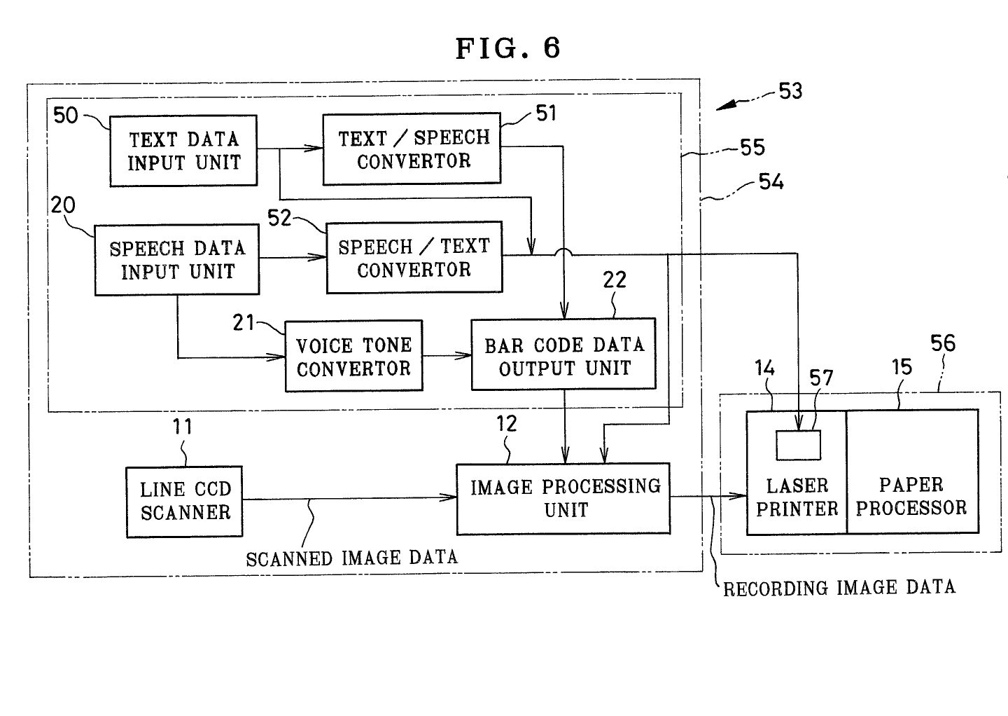

In FIG. 6, another preferred embodiment is depicted. A digital printing system 53 includes a text data input unit 50, a text/speech convertor 51 and a speech/text convertor 52. Elements similar to those in FIG. 1 are designated with identical reference numerals.

An input machine 54 includes a data convertor device 55 in combination with the line CCD scanner 11 and the image processing unit 12. The data convertor device 55 is constructed by the speech data input unit 20, the voice tone convertor 21, the bar code data output unit 22, the text data input unit 50, the text/speech convertor 51, the speech/text convertor 52 and the like. The text data input unit 50 includes a keyboard, mouth and other elements for direct inputting of text data. In addition, the text data input unit 50 is provided with a reader for reading information from a flexible disk, MO or other recording medium, and a communication device in connection with the Internet or other network. The reader and the communication device are used for inputting the text data.

The text data is sent to the text/speech convertor 51 and also to an output machine 56. A back-printing type of text data recorder 57 is incorporated in the laser printer 14 in the output machine 56, and prints letters and the like to a back surface of the photographic paper according to the text data. An example of the text data recorder 57 is a dot impact printer, in which ink is used and has a characteristic free from being influence by development in the paper processor 15. Note that it is also possible to use printers of other types free from being influenced by developing solution or the like, for example an ink jet printer.

The text data recorder 57 also may be a printing device for use with ink, toner, dye or the like, for example an electrophotographic device, plotter or the like.

The text/speech convertor 51 produces speech data from the text data according to a known speech synthesizing technique. The text/speech convertor 51 stores plural sets of conversion control data which causes conversion to voices of a male adult, female adult, male juvenile, and female juvenile. The speech data is sent to the bar code data output unit 22, and converted into bar code data. The image processing unit 12 converts the bar code data into a bar code.

Speech data input to the speech data input unit 20 is sent to the voice tone convertor 21, and also to the speech/text convertor 52 in a selective manner. The speech/text convertor 52 converts the speech data to text data in a conversion technique known to those skilled in the art. The text data is sent to the text data recorder 57, which prints a code, letters or signs to the back surface of the photographic paper.

Note that it is also possible that the text data recorder 57 prints speech data in a form of a code, numbers, letters or signs to the back surface of the photographic paper.

In the present embodiment, the printer has an auxiliary construction for recording the text to a recording surface of the print in addition to the printing of the text data recorder 57. If the text is desired to be recorded to the recording surface, the text data from the text data input unit 50 or the speech/text convertor 52 is sent to the image processing unit 12. The image processing unit 12 effects synthesis to combine the text image with the frame image. In the image synthesis, it is possible to record the text directly beside a speech bar code instead of inserting the text in the image frame.

In the above embodiment, the speech is separated into a pitch component and a spectral envelope component, which are subjected to processing to convert the voice tone. Furthermore, conversion may be effected according to the construction of FIG. 6. Speech data input to the speech data input unit 20 can be converted by the speech/text convertor 52 into text data, which can be converted by the text/speech convertor 51 into speech of a standard tone.

In the above embodiment, a combination of original speech data and conversion data is recorded. Also, the tone-converted speech data is recorded. In addition, it is possible to record text data in a suitable recording form, for example in a bar code form. With this construction, a player device receives the text data, and plays back the speech by conversion of the text data into speech, or also by tone conversion.

In the above embodiment, image frames in the photo film are read by the scanner. However, image data may be retrieved in various manners other than reading of the photo film. For example, image data and speech data may be obtained by use of a digital camera. Image data may be obtained by a scanning operation for an original sheet of any kind. Image data may be obtained from the Internet or a CD-ROM.

A user must bring his or her image data or speech data to a photo finishing agent. To this end, it is possible to use the Internet or other network, or communication cable of telephone, cellular telephone or the like to transmit the image data or speech data.

In the above embodiments, speech data is input by a camera. However, speech data may be input at the time different from that according to the above embodiments, or may be input in a different manner from the above. Specifically, speech data may be input from a sound recorder, telephone, cellular telephone and the like. Speech data may be converted into digital data by a personal computer or the like. Also, speech data may be received by transmission of such digital data through the Internet. Also, the input machine may be provided with a section for acceptance of an order. At the time of acceptance, speech data associated with image data is input. The input machine may have a display panel, which can cause a user or customer to check and confirm a result of the tone conversion.

In the above embodiment, the print is produced by the digital printing system. Furthermore, it is possible to use the construction of the invention in an analog type of printing system in which a light source applies printing light to the photo film, and a printing lens focuses the printing light on photosensitive material for exposure. In such a construction, a bar code exposure station is installed in addition to a frame exposure station, for printing a speech data bar code. In addition to the bar code recording, the speech data may be recorded magnetically or in other suitable manners.

It is also to be noted that a code of a certain form may be predetermined in a manner and may represent both of speech data and text data, so as to make it possible to read a desired one of text and speech. The code may be recorded optically, magnetically, or with ink, toner or dye. Such a code may be constituted by a bar code, a train of numbers, letters or signs, and the like.

In the above embodiment, the printing system is constituted by the combination of the input machine 16, 54 and the output machine 17, 56. However, the input machine 16, 54 and the output machine 17, 56 may be unified in a single printer. Also, a device according to the invention may be an image processing device having the input machine 16, 54 without the output machine 17, 56. Furthermore, a device according to the invention may be an image processing device having the input machine 16, 54 without the line CCD scanner 11. In the above embodiment, the laser printer 14 is included in the output machine 17, 56. However, any suitable type of an image forming device may be used for printing, for example a thermal printer, an ink-jet printer, and the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image processing device for processing image data, comprising:
a speech data input unit for inputting speech data associated with said image data for representing speech;
a voice tone convertor for subjecting said speech data to tone conversion; and
a speech data output unit for outputting said tone-converted speech data in association with said image data.

2. An image processing device as defined in claim 1, wherein said voice tone convertor stores plural sets of tone mode information;
further comprising a voice tone selector for selecting one of said plural sets of said tone mode information, wherein said voice tone convertor subjects said speech data to tone conversion according to said selected tone mode information.

3. An image processing device as defined in claim 1, wherein said voice tone convertor generates conversion data for tone conversion control, and sends said conversion data to said speech data output unit;
wherein said tone-converted speech data is constituted by said speech data before being converted and said conversion data.

4. An image processing device as defined in claim 1, further comprising a text data output unit for outputting text data in association with said image data, said text data representing text.

5. An image processing device as defined in claim 4, further comprising a speech/text convertor for converting said speech data from said speech data input unit into said text data.

6. An image processing device as defined in claim 4, further comprising a text data input unit, externally operable, for inputting said text data.

7. An image processing device as defined in claim 4, wherein said text data includes at least one of a letter, a number and a sign.

8. An image processing device as defined in claim 1, further comprising:
a text data input unit for inputting text data associated with said image data for representing text;
a text/speech convertor for converting said text data into speech data, and sending said speech data to said speech data output unit.

9. An image processing device for processing image data, comprising:
a speech data input unit for inputting speech data associated with said image data for representing speech;
a voice tone convertor for generating conversion data for tone conversion control; and
a speech data output unit for outputting a combination of said speech data and said conversion data in association with said image data.

10. An image processing device for processing image data, comprising:
a data input unit for inputting text data associated with said image data for representing text;
a convertor for converting said text data into speech data for representing speech; and
a data output unit for outputting said speech data in association with said image data.

11. An image processing device as defined in claim 10, wherein said data output unit further outputs said text data in association with said image data.

12. An image processing device for processing image data, comprising:
a data input unit for inputting speech data associated with said image data for representing speech;
a convertor for converting said speech data into text data for representing text; and
a data output unit for outputting said text data in association with said image data.

13. An image processing device for processing image data, comprising:
a text data input unit for inputting text data associated with said image data for representing text; and
a data output unit for outputting said text data and conversion data in association with said image data, said conversion data being adapted to production of speech according to said text data.

14. A printer for printing an image to recording material according to image data, comprising:
a speech data input unit for inputting speech data associated with said image data for representing speech;
a voice tone convertor for subjecting said speech data to tone conversion; and
a speech data recorder for recording said tone-converted speech data to said recording material in association with said image.

15. A printer as defined in claim 14, wherein said voice tone convertor stores plural sets of tone mode information;
further comprising a voice tone selector for selecting one of said plural sets of said tone mode information, wherein said voice tone convertor subjects said speech data to tone conversion according to said selected tone mode information.

16. A printer as defined in claim 14, wherein said voice tone convertor generates conversion data for tone conversion control, and sends said conversion data to said speech data recorder;
wherein said tone-converted speech data is constituted by said speech data before being converted and said conversion data.

17. A printer as defined in claim 14, wherein said recording material is photosensitive material;
further comprising an image forming unit for optically printing said image to said recording material, said image forming unit further constituting said speech data recorder optically to print said speech data.

18. A printer as defined in claim 17, wherein said image forming unit prints said speech data in a bar code form.

19. A printer as defined in claim 14, wherein said recording material includes a magnetic recording region, and said speech data recorder magnetically records said speech data.

20. A printer as defined in claim 14, further comprising:
a speech/text convertor for converting said speech data from said speech data input unit into text data for representing text; and
a text data recorder for recording said text data to said recording material in association with said image.

21. A printer as defined in claim 14, further comprising:
a text data input unit, externally operable, for inputting text data for representing text; and
a text data recorder for recording said text data to said recording material in association with said image.

22. A printer as defined in claim 21, wherein said text data includes at least one of a letter, a number and a sign.

23. A printer as defined in claim 21, wherein said recording material is photosensitive material;
further comprising an image forming unit for optically printing said image to said recording material, said image forming unit further constituting said text data recorder optically to print said text data.

24. A printer as defined in claim 21, wherein said text data recorder prints said text data by use of ink, toner or dye.

25. A printer as defined in claim 14, further comprising:
a text data input unit for inputting text data associated with said image data for representing text;
a text/speech convertor for converting said text data into speech data, and sending said speech data to said speech data recorder.

26. A printer for printing an image to recording material according to image data, comprising:
a speech data input unit for inputting speech data associated with said image data for representing speech;
a voice tone convertor for generating conversion data for tone conversion control; and
a speech data recorder for recording a combination of said speech data and said conversion data to said recording material in association with said image.

27. A printer for printing an image to recording material according to image data, comprising:
a data input unit for inputting text data associated with said image data for representing text;
a convertor for converting said text data into speech data for representing speech; and
a data recorder for recording said speech data to said recording material in association with said image.

28. A printer as defined in claim 27, wherein said data recorder further records said text data to said recording material in association with said image.

29. A printer for printing an image to recording material according to image data, comprising:
a data input unit for inputting speech data associated with said image data for representing speech;
a convertor for converting said speech data into text data for representing text; and
a data recorder for recording said text data to said recording material in association with said image.

30. A printer for printing an image to recording material according to image data, comprising:
a text data input unit for inputting text data associated with said image data for representing text; and
a data recorder for recording said text data and conversion data to said recording material in association with said image, said conversion data being adapted to production of speech according to said text data.
